(19) United States
(12) Patent Application Publication
(10) Pub. No.: US 2006/0182785 A1
(43) Pub. Date: Aug. 17, 2006

(54) System and method for producing foie gras in poultry

(76) Inventors: Daniel Gunnar Peterson, Pismo Beach, CA (US); Elizabeth Allison Koutsos, Pismo Beach, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/356,845

(22) Filed: Feb. 17, 2006

Related U.S. Application Data
(60) Provisional application No. 60/654,209, filed on Feb. 17, 2005.

(51) Int. Cl. A23K 1/165; A23K 1/17

(52) U.S. Cl. 424/442; 426/635

(57) ABSTRACT

A method for producing poultry with CLA enhanced nutritional properties includes preparing a CLA containing diet, selecting a poultry species, feeding the CLA containing diet to the selected poultry species and harvesting at least one of a plurality of CLA enhanced poultry products. A system for producing poultry with CLA enhanced nutritional properties is also disclosed.

### CROSS REFERENCE TO RELATED APPLICATIONS

This application claims priority from U.S. Provisional Patent Application No. 60/654,209 filed on Feb. 17, 2005 and entitled “System and Method for Producing Foie Gras in Ducks,” which is incorporated herein by reference in its entirety.

### BACKGROUND

The present invention relates to the production of foie gras, and more particularly, to systems and methods for feeding ducks, geese and other birds for the production of foie gras.

On Sep. 30, 2004, California Governor Arnold Schwarzenegger signed Senate Bill 1520 (SB 1520) which requires the termination of all force-feeding of ducks, geese and other birds to produce foie gras. Additionally, SB 1520 bans the sale of foie gras in California if it was produced using force-feeding methods. The passage of SB 1520 into law reflects growing animal welfare concerns about certain practices within animal agriculture, and will dramatically impact the duck and goose foie gras businesses in the United States (currently primarily in New York and California).

Force-feeding birds results in foie gras production, simply based upon the fact that increased feed consumption results in increased lipid production in the liver (i.e., excessive lipogenesis). Normally, excessive lipogenesis will exceed the capacity of the liver to export lipid, and results in lipid accumulation in the liver, commonly referred to as steatosis.

In some bird species (e.g., laying hens and broiler chickens), steatosis is associated with reduced performance and increased mortality. However, in ducks and geese, steatosis results in the foie gras product.

### SUMMARY

Broadly speaking, the present invention fills these needs by providing a system and a method for producing poultry with CLA enhanced nutritional properties. It should be appreciated that the present invention can be implemented in numerous ways, including as a process, an apparatus, a system, computer readable media, or a device. Several inventive embodiments of the present invention are described below.

One embodiment provides a method for producing poultry with CLA enhanced nutritional properties including preparing a CLA containing diet, selecting a poultry species, feeding the CLA containing diet to the selected poultry species and harvesting at least one of a plurality of CLA enhanced poultry products.

Feeding the CLA containing diet to the selected poultry specie can include feeding the CLA containing diet to the selected poultry specie during one or more periods within the life of that animal. The life periods can include a starter period, a grower period, a breeding period and a mature period.

The CLA containing diet can include a CLA isomer mixture. The CLA containing diet can include a CLA isomer mixture in addition to a typical diet. The CLA containing diet can include a CLA isomer mixture that replaces at least a portion of a typical diet. The specific isomer content of the CLA isomer mixture can include about 25% to about 50% cis-9, trans-11 CLA and about 25% to about 100% trans-10, cis-12 CLA.

The CLA containing diet can include between about 45 and about 65% carbohydrate, between about 10 and about 25% protein and between about 3 and about 10% fat, wherein the fat includes about 25% to about 100% of the CLA isomer mixture.

The CLA enhanced poultry products can include a fatty liver, a CLA enhanced meat product, and a CLA enhanced egg. Foie gras can be produced using the fatty liver.

Another embodiment provides a method for producing foie gras including preparing a CLA containing diet. The CLA containing diet can include between about 45 and about 65% carbohydrate, between about 10 and about 25% protein and between about 3 and about 10% fat, wherein the fat includes about 25% to about 100% of the CLA isomer mixture. A poultry species is selected and the CLA containing diet is fed to the selected poultry species during at least one period in the life of the animal. One or more CLA enhanced poultry products can be harvested.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 is a block diagram of a typical poultry diet for a starter growth period (about 0 to about 2 weeks of age) and/or a grower growth period (about 2 weeks to about 8 weeks of age).

FIG. 2 is a block diagram of an exemplary CLA supplemented poultry diet for a starter growth period and/or a grower growth period and/or a breeding period and/or a mature period, in accordance with one embodiment of the present invention.

FIG. 3 is a flowchart diagram that illustrates the method operations performed in producing poultry with CLA enhanced nutritional properties, in accordance with one embodiment of the present invention.

FIG. 4 is a pictorial diagram that illustrates producing poultry with CLA enhanced nutritional properties, in accordance with one embodiment of the present invention.

### DETAILED DESCRIPTION

Several exemplary embodiments for a system and method for feeding ducks, geese, chickens and other birds for the production of foie gras and other nutritionally enhanced products will now be described. It will be apparent to those skilled in the art that the present invention may be practiced without some or all of the specific details set forth herein.

Alternative methods for foie gras production are of great interest in order to allow for the foie gras industry to maintain economic viability and meet with consumer demand. Recent developments in the field of lipid biology have revealed a family of fatty acids collectively termed conjugated linoleic acids (CLA) that possess potent and diverse bioactivity.

CLA have been shown to regulate such divergent processes as cancer development, immune function, and lipid metabolism. Specifically, selected forms of CLA have been shown to cause a redistribution of lipid depots in animals. The redistribution of lipid depots can lead to a reduction in body fat accretion, while simultaneously causing steatosis.

Diets containing CLA have been shown to lead to steatosis in mice as well as laying hens. Additional studies in broiler chickens have shown increases in liver mass without additional lipid accumulation (i.e., no excessive lipogenesis). While the basis for these discrepancies in poultry is not clear, it is conceivable that it involves age, strain and/or physiological state.

The studies show that the use of CLA in the diet can induce a fatty liver as an alternative to force-feeding. CLA containing diets would therefore be of great interest to the survival and even expansion of the foie gras industry in California, as well as other areas that may encounter legislation similar to California SB 1520.

As an additional benefit to using CLA for production of foie gras, it has been well established that CLA-containing diets lead to the accumulation of CLA in tissues (including liver, muscles, etc.) of birds. This is of interest due to the widely recognized health benefits associated with particular forms of CLA, including anti-cancer properties, anti-diabetic properties, immune modulation, and more. Diets containing CLA may therefore produce foie gras without force feeding and also provide additional products (e.g., chicken, goose and/or duck meat or other food products) with CLA enhanced nutritional properties. Such CLA enhanced nutritional properties can be exploited not only for their nutritional benefits but also as an important factor in marketing of all animal products.

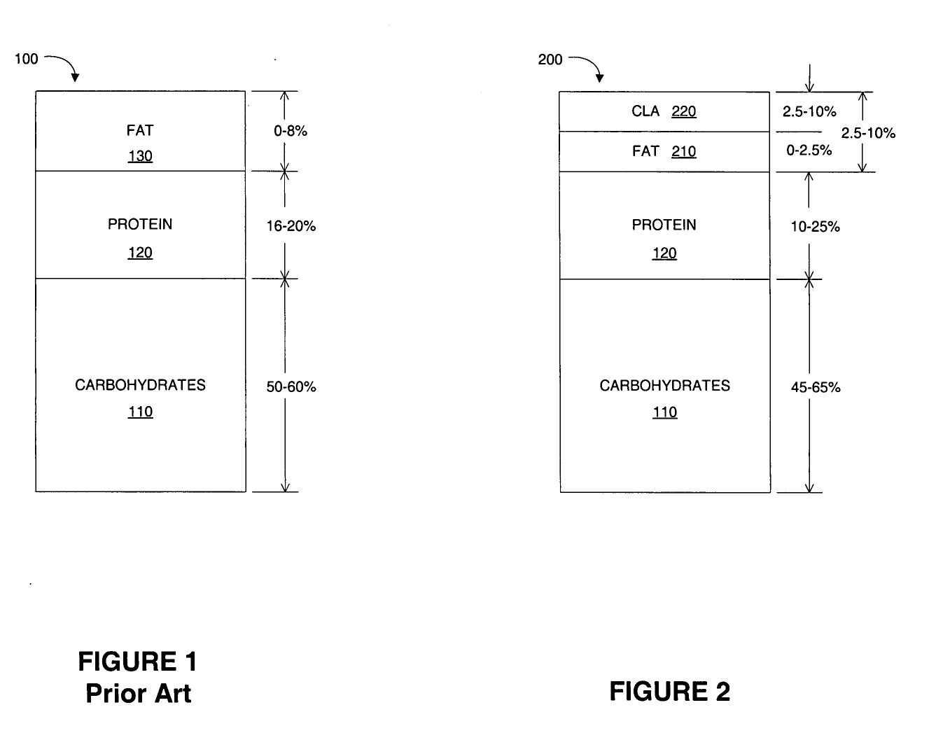

One approach to induce a fatty liver in commercial poultry production is to supplement the typical poultry diets with CLA isomers. FIG. 1 is a block diagram of a typical poultry diet 100 for a starter growth period (about 0 to about 2 weeks of age) and/or a grower growth period (about 2 weeks to about 8 weeks of age). Similarly formulated diets are used for different growth periods or a breeding period or a mature period. The CLA containing diet can include between about 45 and about 65% carbohydrate, between about 10 and about 25% protein and between about 3 and about 10% fat, wherein the fat includes about 25% to about 100% of the CLA isomer mixture and the remainder of the fat includes corn or other vegetable derived oils, or tallow or other animal derived fats. Note that the percentages expressed above are percentage of total weight of the diet.

The CLA supplemented diets can be fed during one or more life periods (growth and/or mature periods) for the poultry. FIG. 2 is a block diagram of an exemplary CLA supplemented poultry diet 200 for a starter growth period, a grower growth period, a breeder period or a mature period, in accordance with one embodiment of the present invention. The starter diet and/or grower diet can be formulated to include a CLA isomer mixture in place of a portion or all of the typical dietary lipid (i.e. fat) components. The exemplary CLA supplemented poultry diet 200 can include between about 50% and about 60% carbohydrates 110 and between about 16% and about 20% proteins 120. The added fat includes about 3% to about 5% of CLA isomer mixture 220. The remaining added fats includes about 0% to about 3% of typical added fats 210. The CLA isomer mixture 220 in the exemplary CLA supplemented poultry diet 200 can include about 25% to about 50% cis-9, trans-11 CLA and about 25% to about 100% trans-10, cis-12 CLA. It should be understood that the foregoing are merely exemplary proportions of CLA that are added to the diet and that other proportions of CLA, either greater of lesser, may be added to the diet 200 to achieve the desired effect in the desired poultry.

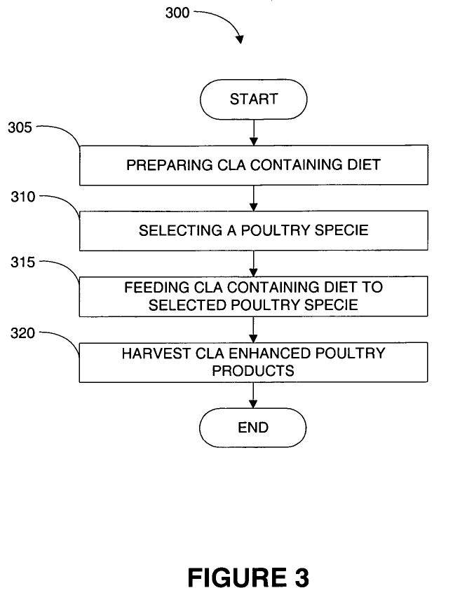

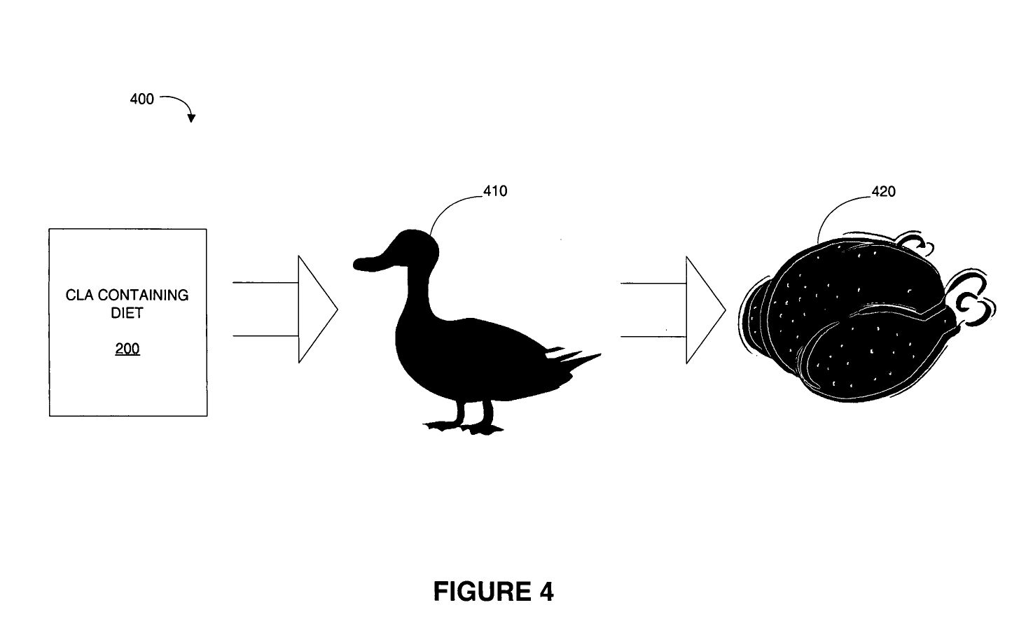

FIG. 3 is a flowchart diagram that illustrates the method operations performed in producing poultry with CLA enhanced nutritional properties 300, in accordance with one embodiment of the present invention. FIG. 4 is a pictorial diagram that illustrates producing poultry with CLA enhanced nutritional properties 400, in accordance with one embodiment of the present invention. In an operation 305, a CLA containing diet such as described in FIG. 2 above can be prepared. In an operation 310, a selecting species 410 (e.g., chicken, laying hens, broilers, ducks, geese, or other species) to feed the CLA containing diet 200.

In an operation 315, the CLA containing diet 200 is fed to the selected species 410 for the desired period or periods (e.g., one or more growth periods or other selected duration). In an operation 320 one or more CLA enhanced products 420 are harvested. By way of example a laying hen can be fed the CLA containing diet 200 to produce CLA enhanced eggs. Similarly, ducks and/or geese can be fed the CLA containing diet 200 to produce CLA enhanced liver for use in the production of foie gras. In addition, chickens, ducks and/or geese can be fed the CLA containing diet 200 to produce CLA enhanced meat products 420.

It will be further appreciated that the instructions represented by the operations in the above figures are not required to be performed in the order illustrated, and that all the processing represented by the operations may not be necessary to practice the invention.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for producing poultry with CLA enhanced nutritional properties comprising:
preparing a CLA containing diet;
selecting at least one of a plurality a poultry species;
feeding the CLA containing diet to the selected poultry species; and
harvesting at least one of a plurality of CLA enhanced poultry products.

2. The method of claim 1, wherein the feeding the CLA containing diet to the selected poultry specie includes feeding the CLA containing diet to the selected poultry specie during one or more of a plurality of life periods.

3. The method of claim 2, wherein the plurality of life periods includes a starter period, a grower period, a breeding period, and a mature period.

4. The method of claim 1, wherein the CLA containing diet includes a CLA isomer mixture.

5. The method of claim 4, wherein the CLA containing diet includes a CLA isomer mixture in addition to a typical diet.

6. The method of claim 4, wherein the CLA containing diet includes a CLA isomer mixture replaces at least a portion of a typical diet.

7. The method of claim 4, wherein a fat content of the CLA containing diet includes about 25% to about 50% cis-9, trans-11 CLA and about 25% to about 100% trans-10, cis-12 CLA.

8. The method of claim 4, wherein the CLA containing diet includes:
between about 50 and about 60% carbohydrate;
between about 16 and about 20% protein; and
between about 4 and about 8% fat, wherein the fat includes about 50% to about 100% of the CLA isomer mixture.

9. The method of claim 1, wherein the plurality of CLA enhanced poultry products includes a fatty liver, a CLA enhanced meat product.

10. The method of claim 9, further comprising producing foie gras with the fatty liver.

11. A method for producing foie gras comprising:
preparing a CLA containing diet including:
between about 45 and about 65% carbohydrate
between about 10 and about 25% protein
between about 3 and about 10% fat, wherein the fat includes about 25% to about 100% of the CLA isomer mixture
selecting at least one of a plurality a poultry species;
feeding the CLA containing diet to the selected poultry species during at least one of a plurality of growth periods; and
harvesting at least one of a plurality of CLA enhanced poultry products
